(19) United States
(12) Patent Application Publication
(10) Pub. No.: US 2014/0129578 A1
(43) Pub. Date: May 8, 2014

(54) SYSTEM AND METHOD FOR CARPOOL MATCHING

(71) Applicant: SAP AG, Walldorf (DE)

(72) Inventor: Jens Lehmann, Sunnyvale, CA (US)

(73) Assignee: SAP AG, Walldorf (DE)

(21) Appl. No.: 13/672,640

(22) Filed: Nov. 8, 2012

(51) Int. Cl. G06F 17/30

(52) U.S. Cl. 707/758; 707/E17.014

(57) ABSTRACT

A carpooling system and method provides users with opportunities to test both user information and priority options (carpool preferences) prior to registration. Upon receipt of carpool preferences, the system determines available matches and displays them to the user. From the available matches provided, the user can visualize how carpool preference information alters the scope of his available matches and he may then change his user carpool preference information accordingly. The system will then store the previously entered user information in a user profile upon registration.

### TECHNICAL FIELD

The present invention is directed to systems and methods for testing and registering user-provided information in network systems, in particular, directed to systems and methods for testing and registering a user's carpool preference information among the registering party, the network administrator, and other users.

### BACKGROUND

Carpooling is an efficiency innovation that allows for conservation of energy and resources. Multiple interested parties to a carpool may initiate their ride at one or more starting locations and may be headed to one or more destinations. A carpool typically involves one driver and at least one passenger, and in certain carpools, individuals may alternate filling the driver role. By carpooling, the members decrease road congestion, save money, and decrease their carbon footprints.

Many barriers exist to the formulation of carpools. First, prospective carpoolers are not always aware of other people who may be interested in joining a carpool. This lack of awareness disables the entire carpool formation process. Second, prospective carpoolers are unwilling to enter into a carpool experience with people who are incompatible with their set of personal preferences. For instance, the prospective carpooler may be inflexible with respect to variations in detour distance, carpool partner gender, departure/arrival times, carpool role as driver versus passenger, etc.

To assist in increasing the awareness of available carpooling parties, there exist carpooling systems. These carpooling systems allow a prospective carpooler, a “user”, to register and then to set a number of personal preferences to ensure that a system finds a carpooling match for the user. The system then either returns a carpool match to the user that most closely met the user's personal preferences or alerts the user that no carpool matches were available.

However, carpool systems leave much to be desired, and further barriers with these carpool systems hinder the formulation of carpools. First, immediate detailed registration processes often deter users from exploring their carpool matches. A registration process collecting detailed information may take a user a substantial amount of time to fill out, and the user may be unwilling to complete such a tedious form.

Second, carpool systems often have registration processes that present the user with fields already populated with various “default” values. These default values are often not selected with any degree of particularity and may be discouraging to a user and provide the user with a negative first experience of the system.

Third, carpool systems often have registration processes that leave users uncertain as to how the preference data entered will affect his carpool match. The preference data entered simply leads to a carpool match, but users are unaware as to how slight variations in choices may alter the presented carpool match.

### BRIEF DESCRIPTION OF THE DRAWINGS OF THE EXAMPLE EMBODIMENTS

FIG. 1 is a flow chart illustrating a method for setting up carpooling arrangements in accordance with an embodiment of the disclosed invention.

FIG. 2 illustrates an exemplary portal page that presents various fields that could be filled out by a user prior to registration to assist the user in testing the carpool matching process

FIG. 3 illustrates a network diagram of a carpooling system constructed in accordance with an embodiment of the disclosed invention.

### DETAILED DESCRIPTION OF THE EXAMPLE EMBODIMENTS

Current art for carpooling systems and methods require users to register prior to investigating their carpool matches. In addition, after registration the current art provides users with a single carpool match as an assignment. Since the purpose of carpooling is to create an efficient form of transportation for the user, there is a need for systems and methods that provide users with transparency regarding the carpool matching algorithm and also allow the user to select at least one carpool match from available matches.

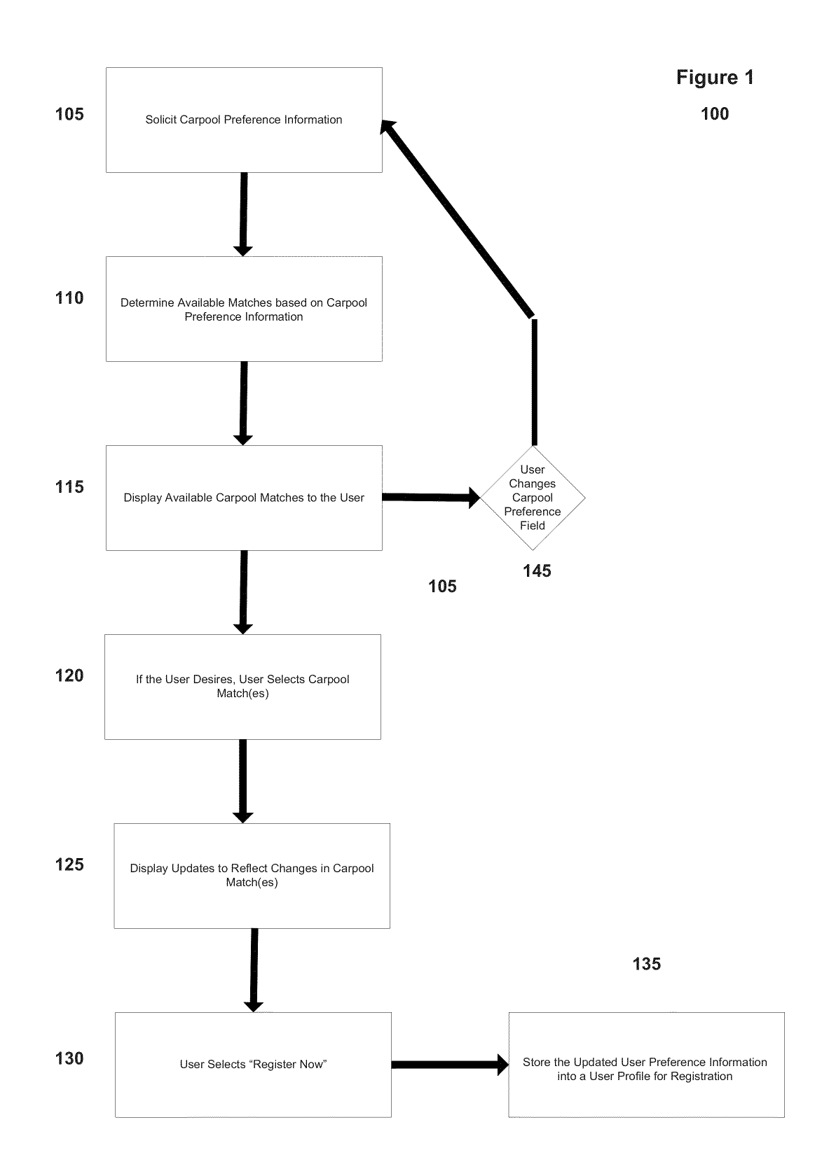

FIG. 1 illustrates a method 100 to solicit the user for carpool preference information prior to registration. Carpool preference information may include user information and priority options. The system first solicits carpool preference information from the user 105. Once the user provides user information and priority options, the system determines available matches for the user 110. The available carpool matches that correspond to the user's information are then displayed 115. In one embodiment, the user selects one or more carpool matches 120. The display then updates to reflect an itinerary composed of a route combining each selected carpool match 125. Upon user satisfaction with the carpool itinerary, the user may select the “Register Now” button 130. As a result, the system will store the user information in a profile 135. If the user is not satisfied with the available matches at any point, the user may change any element of user information accordingly 140. In another embodiment, the system selects at least one carpool match and assigns it to the user 120. Upon assignment of the carpool match, the user may select the “Register Now” button 130.

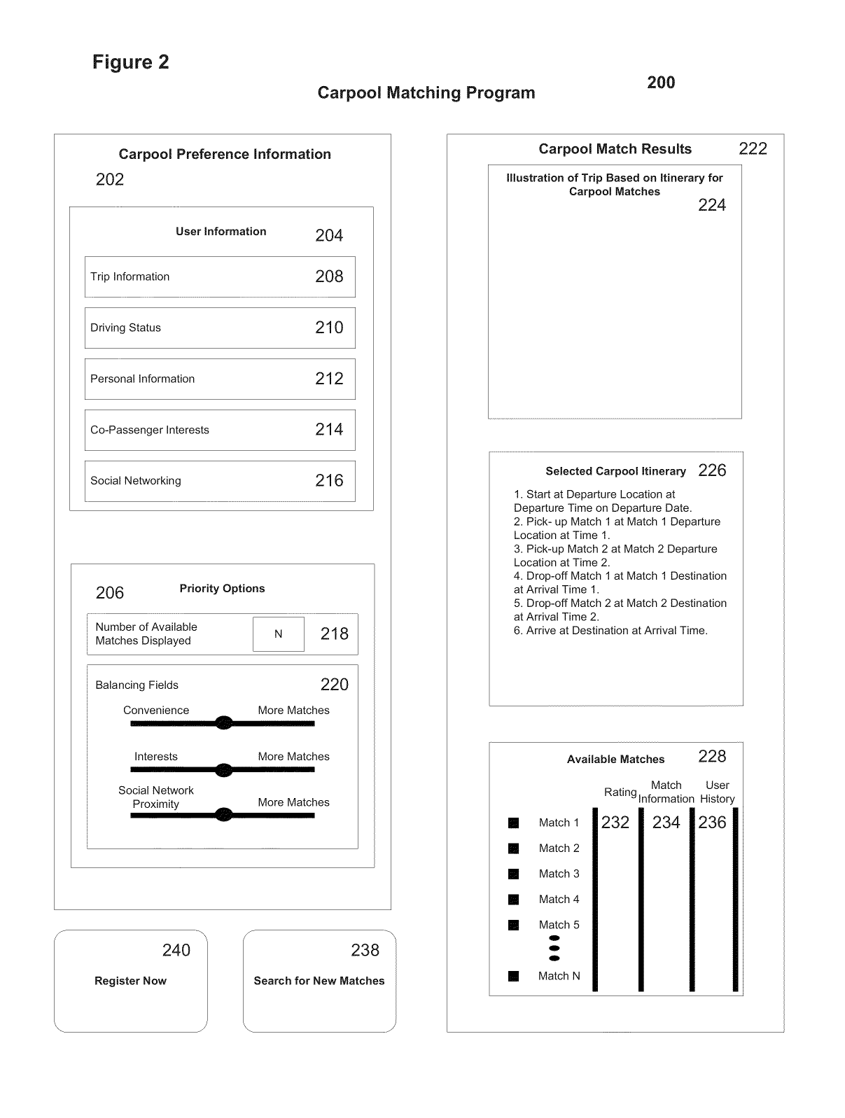

FIG. 2 illustrates an exemplary portal page 200 that implements the carpool match testing (probing) system and method. In one embodiment of the invention, user information 204 may contain “Trip Information” 208. Trip Information may contain fields soliciting the user for data that could contain, for example, at least: driving distance, arrival time, departure time, arrival/departure flexibility time, maximum detour time, shared duration time, start travel date, end travel date, round trip, recurring event, and number of passengers. In this embodiment, driving distance represents the maximum mileage that the user is willing to travel in a single direction carpool trip. Arrival time represents the time of day at which the user may like to reach his destination. Start travel date represents the day that the user may like to begin his journey. Departure time represents the time of day at which the user may like to return from his destination. End travel date represents the day that the user leaves his destination. Maximum detour time represents the time that the user is willing to stray from his most efficient route. Shared duration time represents the minimum period of time that the user is willing to carpool with another person. Round trip represents whether the user requires a ride in both directions to and from his destination. Recurring event represents whether the user may like to set-up a repeat carpool matching process. Number of passengers represents a maximum number of people that the user feels comfortable traveling with, either including or excluding the driver.

A second embodiment of the invention may collect user information 204 regarding “Driving Status” 210. Driving Status may contain fields soliciting the user for data that could contain at least: driver role, number of seats, type of car, and driver experience. In this embodiment, driver role represents whether the user will volunteer to drive the carpool or will act as a passenger. Number of seats represents a driver's number of available passenger seats. Type of car represents a driver's car model information. Driver experience represents the number of years that the driver has been licensed.

A third embodiment of the invention may collect user information 204 regarding “Personal Information” 212. Personal Information may contain fields soliciting the user for data that could contain at least: name, gender, origin, destination, personal habits, telephone number, and email. Origin represents the user's starting location, and destination represents the user's ending location. Personal habits represents the user's personal tendencies that could include at least: smoker/non-smoker, timeliness, and cleanliness.

A fourth embodiment of the invention may collect user information 204 regarding “Co-Passenger Interests” 214. A user may select an interest with the intention of seeking passengers who select similar interests. Co-passenger interests may contain fields soliciting the user for data that could contain at least: badges, company/work-place, and gender. An exemplary feature of the invention may include a field soliciting the user for “badges.” A badge represents an interest that a user might desire from his co-passenger. By selecting a particular badge from a provided collection of badges, the user will quickly be able to find co-passengers that have expressed similar interests. Examples of a badge that may be selected from a collection of badges may be “Coffee-Lover” or “Traveling.”

A fifth embodiment of the invention may collect user information 204 regarding “Social Networking” 216. By entering into the applicable field social network account information and allowing an external website to connect with the current portal, the user may quickly populate many user preferences information fields. Additionally, by connecting with an external social media website, a user may be able to relax security settings and reveal more personal details specifically to social media connections in their corresponding “Available Matches” section of the carpooling portal.

A sixth embodiment of the invention may collect priority options 206 regarding the user's “Available Matches” 228. In this embodiment, a field within priority options may include the number of carpooling matches that the user may like to have displayed for his review 218. In another embodiment, priority options may include at least one balancing field 220. These balancing fields or other fields in the priority options may be preset to display default information. An example of a balancing field may include a user balancing the convenience of the carpooling match trip and the number of matches displayed. For instance, the user could determine that he wants to see more matches displayed in the Available Matches section despite including some trips with longer detour times. Another balancing field may solicit the user to balance the similarity of his interests and the number of matches displayed. For instance, the user could determine that he wants to see more matches displayed in the Available Matches section despite including some trips with other users who have less in common with the user's Co-Passenger Interests section of his preferences information. Another balancing field may solicit the user to balance his proximity to others in social media circles and the number of matches displayed. For instance, the user could determine that he wants to see fewer matches displayed in the Available Matches section and instead narrow the pool to those who are in similar social media circles.

Another embodiment of the invention allows a user to see his carpool match results 222 and to see his updated carpool matches after altering any particular field of the user information. In this embodiment, after the user has made any field changes on the portal, the Available Matches 228 automatically refresh and repopulate with a new set of carpool matches that reflect the most recent changes made.

Alternatively, in another embodiment of the invention, a user may make several changes in several fields of the user information without initiating an immediate refreshing of the Available Matches. In this embodiment, the user must select a “Search for New Matches” button 238 that updates the Available Matches 228 to reflects several different changes all at once.

In another embodiment of the invention, the list of Available Matches is accompanied with an illustration of the Itinerary in map form 224. In this embodiment, the user must select at least one of the available matches 230 and based on the user carpool match selection, the illustration 224 will update to provide the user with the corresponding carpool route.

In another embodiment of the invention, the list of Available Matches is accompanied with a written itinerary 226. In this embodiment, the user must select at least one of the Available Matches 228 and based on the user carpool match selection, the itinerary will update to provide the user with the corresponding carpool route.

In another embodiment of the invention, the list of Available Matches is accompanied with a rating of the driver or passenger 232. In this embodiment, the user can see reviews of the past users who have interacted with the particular driver or passenger presented as an Available Match 228.

In another embodiment of the invention, the list of Available Matches is accompanied with “Match Information” 234, which reveals why the carpool match is suggested to the user. In this embodiment, the Match Information may be presented at least in graphic or text form. Match Information may reflect what elements of user information were considered most important in selecting that particular carpool match to populate the Available Matches 228 list.

In another embodiment of the invention, the list of Available Matches is accompanied with “User History” 236. In this embodiment, User History will represent to the user in at least graphic or text form whether or not the user has joined the carpool match for a prior carpool experience.

Embodiments of the present invention may include a system and method that finalizes the carpooling matching process upon a user's selection of a “Register Now” button 240. In this embodiment, the Register Now button will take the user to a second portal page that finalizes the user's registration, e.g. asking the user to provide an email address and choose a password. In this embodiment, the user information that was collected in the above-described ‘testing phase,” as well as that given on the registration page, is stored as a user profile. The second portal page will then confirm the user's itinerary and set-up the carpool.

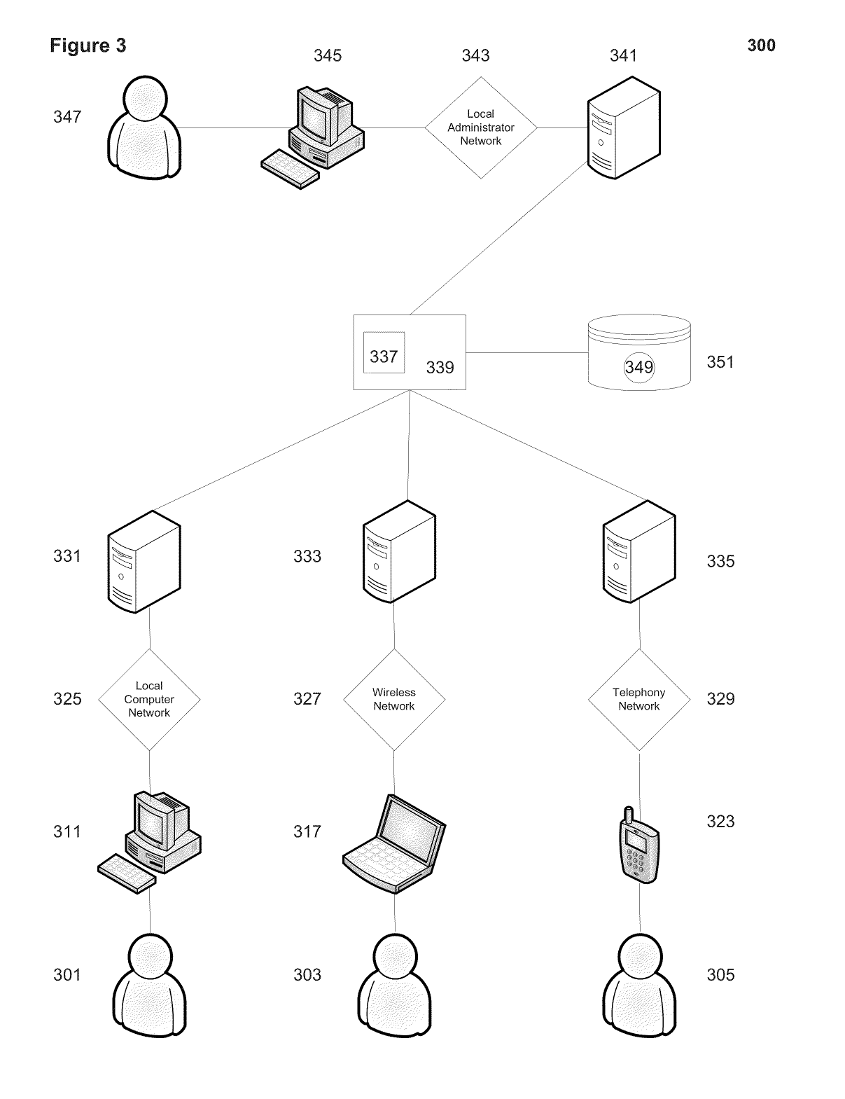

In FIG. 3, another embodiment of the present invention is illustrated. FIG. 3 depicts an implementation of a carpool matching system 300 over a series of networks. The network is accessed by a plurality of players including at least: the user 301, other users 303 and 305, and the network administrator 347. Users access the carpool matching system through a portal that interacts with a browser on their corresponding user devices. The portals provide a web page interface using communication standards such as HTTP and internet protocol. Example user devices include at least a personal computer 311, a laptop 317, and an internet capable phone 323. Personal computer 311 sends an email, or a meeting request, that is handled by a local computer network 325. The request is then handled by a server 331, which interacts with the carpool matching server 339. Similarly, laptop 317 sends a data packet that is handled by local wireless network 327. The data packet is then handled by a server 333, which interacts with the carpool matching server 339. User 305 may similarly interact by sending either an SMS text message or data packet over the telephony network 329, which is then handled by a server 335. The server 335 interacts with the carpool matching server 339. Embodiments of the invention could occur with client side or server side rendering. A network administrator 347 accesses the carpool matching server 339 from his user device 345 over a local network 343 and server 341. The carpool matching server 339 contains a processor 337 that drives the carpool matching system. The processor 337 may request data from the carpool matching server, which will query the local database 351. Local database 351 includes at least memory element 349, which may contain data pertaining to registered user information and user profiles.

In the above description, the present invention has been described with reference to particular examples, instances, and embodiments. However, it must be understood that the present invention is not limited to these examples and embodiments. Furthermore, these embodiments may be used in various combinations and in the absence of one another. As a result, the present invention includes variations from the specific examples and embodiments described herein, as may be apparent to one of skill in the art.

What is claimed is:

1. A method for carpool matching, comprising:
soliciting carpool preference information from a user;
determining available carpool matches that correlate to the carpool preference information provided by the user;
displaying the available carpool matches to the user; and
storing, upon a user request for registration, the carpool preference information in a user profile,
wherein the carpool preference information includes at least user information.

2. The method of claim 1, wherein the user selects at least one carpool match from the available carpool matches.

3. The method of claim 1, wherein the user is assigned to at least one carpool match.

4. The method of claim 1, wherein the user information includes at least one of trip information, personal information, and driving status information.

5. The method of claim 1, wherein the user information includes co-passenger interests.

6. The method of claim 1, wherein the user information integrates social network information from an external server.

7. The method of claim 1, wherein the user updates the user information to generate a new set of available matches.

8. The method of claim 1, wherein the user information includes an option to set-up recurring carpool matches.

9. The method of claim 1, wherein the carpool preference information includes priority options.

10. The method of claim 9 wherein the priority options are pre-set to display default information.

11. The method of claim 9, wherein the priority options include a field to change the number of available carpool matches displayed.

12. The method of claim 9, wherein the priority options information includes a field to change the number of available carpool matches displayed.

13. The method of claim 1, wherein the user request for registration occurs when the user selects a Register Now option.

14. A carpooling matching system, comprising:
a processor that is configured to:
receive carpool preference information from a user,
determine available carpool matches that correlate to the carpool preference information, and
provide the available carpool matches to a user device; and
a database having stored thereon carpool preference information in a user profile, wherein the carpool preference information includes at least user information.

15. The system of claim 14, wherein the user selects at least one carpool match from the available carpool matches.

16. The system of claim 14, wherein the user is assigned to at least one carpool match.

17. The system of claim 14, wherein the user information includes at least one of trip information, personal information, and driving status information.

18. The system of claim 14, wherein the user information includes co-passenger interests.

19. The system of claim 14, wherein the user information integrates social network information from an external server.

20. The system of claim 14, wherein the user updates the user information to generate a new set of available matches.

21. The system of claim 14, wherein the user information includes an option to set-up recurring carpool matches.

22. The system of claim 14, wherein the carpool preference information includes priority options.

23. The system of claim 22, wherein the priority options are pre-set to display default information.

24. The system of claim 22, wherein the priority options include a field to change the number of available carpool matches displayed.

25. The system of claim 22, wherein the priority options information includes a field to change the number of available carpool matches displayed.

26. The system of claim 14, wherein the user profile is created upon a user request for registration, which occurs when the user selects a Register Now option.

27. A computer-implemented method, comprising:
displaying, by a processor, a first user interface including a plurality of fields for a user to enter at least one of user information and priority option;
determining, by the processor, carpool matches based on the at least one of the user information and the priority option entered by the user;
displaying, by the processor, the carpool matches to the user for the user to select one of the carpool matches;
in response to user selection of a carpool match, displaying, by the processor, a second user interface for user to register; and
in response to user registration, storing, by the processor, the at least one of the user information and priority option in a user profile.
